(19) United States
(12) Patent Application Publication
(10) Pub. No.: US 2023/0111684 A1
(43) Pub. Date: Apr. 13, 2023

(54) PLASTIC ROLL-OFF CONTAINER

(71) Applicant: John W. Jordan, Montgomery, AL (US)

(72) Inventor: John W. Jordan, Montgomery, AL (US)

(21) Appl. No.: 17/496,524

(22) Filed: Oct. 7, 2021

(51) Int. Cl. B65F 3/26; B65D 88/12; B65D 90/16; B65G 67/02; B60P 1/64

(52) U.S. Cl. CPC B65F 3/26; B65D 88/123; B65D 90/16; B65G 67/02; B60P 1/6454; B60P 1/649

(57) ABSTRACT

A plastic roll-off container is disclosed, including a roll-off container comprising a front side and a rear side. The roll-off container is configured, via a first rail and a second rai positioned on a bottom side of the roll-off container, to be onloaded, offloaded, and transported by a roll-off truck or a hook lift roll-off truck. An integrally molded sidewall is connected to a bottom having a concave shape to facilitate the removal of a material from an interior of the roll-off container.

### CROSS-REFERENCE TO RELATED APPLICATIONS

The present application claims priority to U.S. Provisional Patent Application 62/825,716 filed on Mar. 28, 2019, entitled “PLASTIC ROLL-OFF CONTAINER” the entire disclosure of which is incorporated by reference herein.

### TECHNICAL FIELD

Embodiments of the invention relate to waste management solutions and more particularly to roll-off containers which are transportable by trucks.

### BACKGROUND

A roll-off container (often simply referred to as a “roll-off”) is an open top container (or dumpster) characterized by a rectangular footprint which utilize wheels to facilitate rolling the container onto and off of a specialized roll-off truck. There are two common delivery trucks which transport, onload and offload roll-off containers based on the roll-off container's size. These are currently hook lift bins and roll-off bins. Roll-off containers are most often used to contain loads of construction waste, demolition waste, or other forms of waste. They include a swinging door on one end to allow the waste to be easily removed from the container. However, some roll-off bins may include a closed top, such as those used in conjunction with a trash compactor.

In use, once a traditional roll-off container is done being used at a location it is loaded onto a truck and is transported to a disposal facility. The roll-off truck raises its hydraulically operated bed resulting in the roll-off dumpster rolling off the bed. A cable may be used to slowly roll the container off of the hydraulically operated bed and pull the container back onto the truck via a winch once it is unloaded. If no winch is present, then the truck utilized a hook-lift system which uses an arm with a hook on the end to lift the container off of and/or onto the truck bed.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a plastic roll-off container, including a roll-off container comprising a front side and a rear side. The roll-off container is configured, via a first rail and a second rai positioned on a bottom side of the roll-off container, to be onloaded, offloaded, and transported by a roll-off truck or a hook lift roll-off truck. An integrally molded sidewall is connected to a bottom having a concave shape to facilitate the removal of a material from an interior of the roll-off container.

In one aspect, the roll-off container is constructed of plastic which may include plastic compositions and plastic fiber mixtures. Constructing the roll-off container of plastic reduces the overall weight of the container and thus increases the weight of materials which can be placed therein while conforming to transportation regulations.

In one aspect, the use of plastic reduces the likelihood that the container will damage the surfaces which it is placed on during loading, unloading, or transportation.

In one aspect, the use of plastic eliminates the possibility of the container rusting which is common with metal containers known in the arts.

In one aspect, the bottom of the container is integrally molded to a sidewall.

In one aspect, the bottom is concave.

In one aspect, an interior of the roll-off container is beveled.

In one aspect, a lip forms a top edge of the roll-off container.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates prior art showing a perspective view of a rectangular roll-off container, according to some embodiments;

FIG. 2 illustrates a perspective view of the roll-off container, according to some embodiments;

FIG. 3 illustrates a perspective view of the bottom side of the roll-off container, according to some embodiments; and

FIG. 4 illustrates a perspective view of the roll-off container while being unloaded from a truck, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a roll-off container which may be constructed of a plastic material including generally known plastics, plastic compounds, or plastic fiber mixtures. The roll-off container is designed to be transported by a roll-off or hook lift roll-off truck. The plastic roll-off is any container that is made of plastic, plastic compound or plastic fiber mixture that is designed to be transported by a roll-off or hook lift roll-off truck. The plastic roll-off container may be utilized as a waste dumpster that can be delivered to a particular location with a roll-off or hook lift roll-off truck.

As used herein, the term “vehicle” and/or “truck” are utilized to describe a truck which onloads, transports, and offloads roll-off containers. This may include roll-off trucks and hook lift roll-off trucks which are known in the arts. The embodiments of the present invention provide a plastic roll-off container that is designed to be onloaded, transported, offloaded, and emptied by a roll-off or hook lift roll-off truck.

As used herein, the term “plastic” may refer to any plastic composition known in the arts including plastic fiber mixtures. The plastic roll-off container may be produced using any suitable means of plastic product production known in the arts.

As used herein, the term “material(s)” is used to refer to the contents which are placed, transported in, and emptied from the roll-off container described herein. The materials may include general waste, construction waste, demolition debris, environmental waste, laboratory waste, or other contents which are often transported in traditional rectangular roll-off containers.

The plastic roll-off container is impervious to rust which is often found in traditional metal containers. This allows the plastic roll-off container to transport materials which would normally be hazardous to the metal containers, providing a longer usage time without significant degradation.

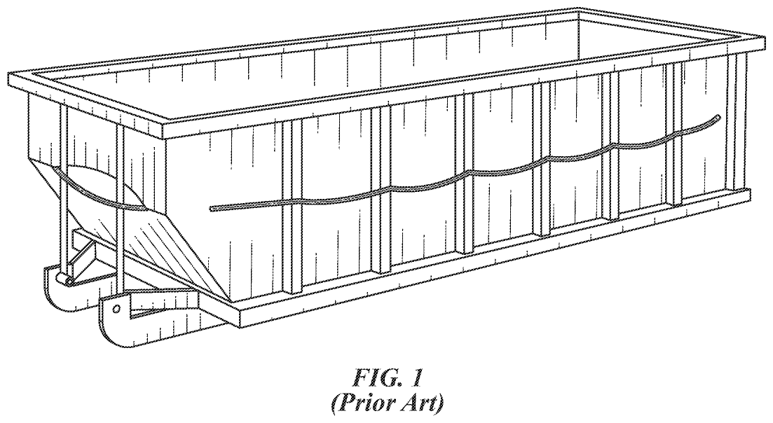

FIG. 1 illustrates prior art showing a perspective view of a rectangular roll-off container which is known in the arts. The rectangular roll-off containers are constructed of metal and often include a swinging door to provide access to the interior of the container. The metal construction is significantly heavier than the embodiments provided by the invention herein. Further, the metal construction is prone to rust and degradation over time, especially if left outdoors, or contacted by a corrosive agent. This shortcoming in the prior art is improved upon by the embodiments described herein.

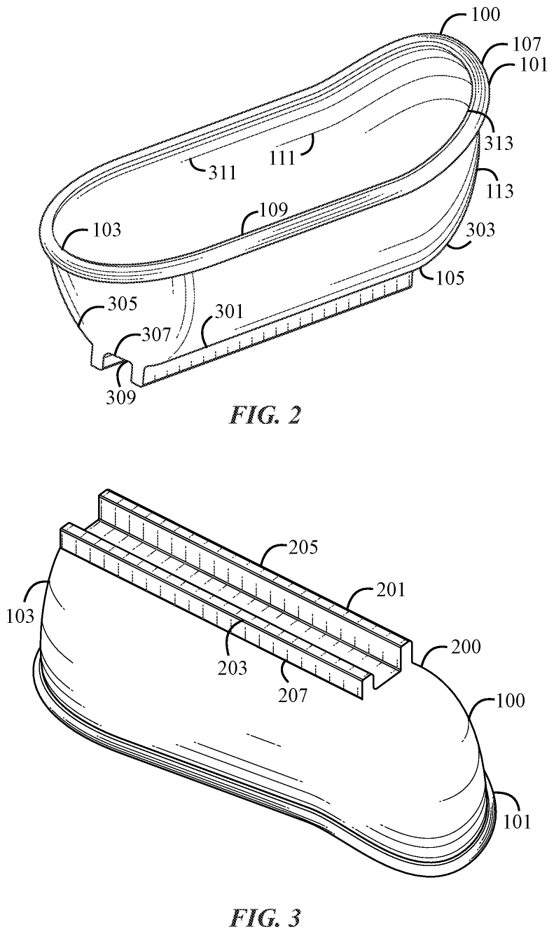

FIG. 2 illustrates a perspective view of the roll-off container 100 according to an exemplary embodiment. The roll-off container 100 having a front side 101 and a rear side 103. The front side is positioned toward the forward end of a truck when loaded thereon and the read side 103 is positioned toward the rear end of the truck when loaded thereon. The rear side 103 includes a rear sidewall which forms an obtuse angle with the bottom 105 of the roll-off container 100. The obtuse angle facilitates the dumping of materials disposed within the roll-off container 100. A lip 107 forms the top edge 109 of the roll-off container 100. The lip 107 is smooth to allow the flow of material from the interior 111 of the roll-off container as the material stored therein is being emptied. The lip 107 may facilitate the attachment of covering (e.g., a tarp) during transport of the at least partially loaded roll-off container to prevent materials therein from exiting the interior 111 wherein the materials are stored. The dimensions and construction of the roll-off container 100 allow multiple similar roll-off containers 100 to be stacked on one another during storage or transportation (e.g., on a truck, by rail, by sea, or other means of transportation).

In further reference to FIG. 2, the interior 111 includes beveled portions 301, 303, 305, 307 include concave central surface 309 to aid in the removal of the materials disposed therein. The interior 111 includes an integrally molded sidewall 311 which provides a resilient barrier for storing hazardous, abrasive, and/or corrosive materials within the interior 111 of the roll-off container 100. The plastic used to construct the roll-off container 100 may be beneficial in prevent corrosion of traditionally metal components. The lip 107 is comprised of a curved edge 313 which facilitates the dumping of materials.

In some embodiments, the interior 111 of the roll-off container 100 is suitable for storing trash including environmental waste, industrial waste, construction waste, demolition debris, and other materials commonly transported in traditional rectangular roll-off containers. The interior may be beveled and concave to aid in the removal of the materials disposed therein.

In some embodiments, the rear side 103 of the interior 111 of the roll-off container 100 has an outwardly elongated wall 113 that is not greater than the exterior wall of the roll-off container 100. This elongated interior allows the roll-off container to be stacked or nested when not in use or when being shipped.

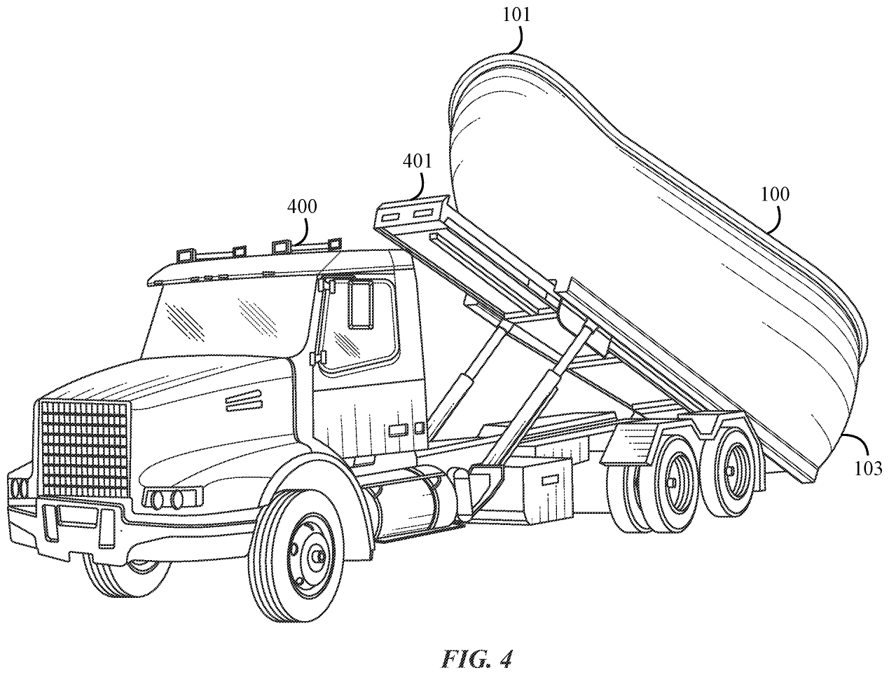

FIG. 3 illustrates a perspective view of the bottom side 200 of the roll-off container 100. The bottom side 200 is comprised of a first rail 201 and a second rail 203. The first rail 201 is positioned nearmost a left side 205 and the second rail 203 is positioned nearmost a right side 207 of the roll-off container 100. Each rail 201, 203 facilitates the roll-off container 100 sliding onto and off of the truck when onloading and offloading the roll-off container 100. The rails 201, 203 extend at least partially along the length of the roll-off container 100 and may extend from the front side 101 to the rear side 103.

FIG. 4 illustrates a perspective view of the roll-off container 100 while being positioned on a truck 400 during the unloading or offloading of the roll-off container 100. The roll-off container 100 may be transported using a roll-off truck or a hook lift roll-off truck as described hereinabove. To empty the material out of the roll-off container 100, a hook is connected to a special 2nd hookup location at the bottom by the front side 101 that lifts the front side 101 of the roll-off container to a about 90-degree angle (i.e., an angle suitable to result in the evacuation of material from the interior of the roll-off container 100). The trash inside container then slides out of the rear side 103 of the roll-off container 100 into a waste receptacle (not shown). Once the interior of the roll-off container 100 is emptied, the roll-off container 100 is pulled back on the bed 401 of the truck 400. The interior volume of the roll-off container 100 has an elliptical shape.

In some embodiments, and when in use, plastic roll-off container 100 is filled with material and prior to the transportation of the roll-off container 100, a tarp is affixed over open top of the roll-off container 100. A hook lift or cable roll-off truck may then load the roll-off container 100 and transports the roll-off container 100 and either empties or stores roll-off container 100 at a suitable location. The unique shape of the interior of the container allows for material to be removed more efficiently. As the hydraulic truck bed tilts the container, the material within the interior shifts to evacuate the material more efficiently than a rectangular container.

In some embodiments, a loading bar may be mounted on the hood or top of the truck. The loading bar prevents material from being evacuated when loading a full or partially full plastic roll-off container onto the truck.

In some embodiments, the plastic roll-off container 100 is designed such that it can be stacked on top of one another such that a plurality of plastic roll-off containers 100 can be shipped by truck or rail while in a stacked configuration. This allows for significantly more plastic-roll off containers 100 to be shipped in a single load than the prior art is capable of. The plastic roll-off containers 100 can also be stacked tightly after delivery to retail home improvement locations and can be stored outside since the plastic material is not vulnerable to rust. Further, the plastic material used to construct the roll-off containers 100 are significantly lighter than traditional metal containers, making them easier to transport and store. Further, due to regulations when transporting loads on a truck, a heavier load (i.e., a heavier total amount of materials) can be placed within the roll-off container while still conforming to gross-weight regulations.

The plastic material used for the construction allows for the roll-off containers 100 to be manufactured at a lower cost when compared to metal roll-off containers. Further, the plastic roll-off containers reduce the shipping costs between the manufacturer, retailer, and/or consumer thus further reducing the price of the roll-off containers 100. The perimeter of the plastic roll-off container 100 may be reinforced with either one or two metal bands at the top and middle to keep the roll-off container 100 from losing its shape, form or damage from holding a heavy material such as dirt or roofing metal covering for the skids underneath the roll-off container can also be an option depending upon the desired application of the roll-off container.

The plastic roll-off container, in its invented form, can be sold or rented in retail locations or sold and rented via a website or phone order. It can be used as a waste container or a storage container. It can be covered with a tarp and stored outside and not be vulnerable to the elements due to the plastic construction material.

In some embodiments, each plastic roll-off container includes at least one hook access point. When compared to the metal containers in the prior art, the plastic roll-off container may eliminate the need for a receiving hook on the container. In one example, the at least one hook access point accepts a hook attachment which includes a safety chain and cotter key.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A roll-off container, comprising:
a roll-off container comprising a front side and a rear side;
an integrally molded sidewall integrally molded with a bottom;
a first rail and a second rail each positioned on a bottom side of the roll-off container;

2. The roll-off container of claim 1, wherein the roll-off container is constructed of plastic.

3. The roll-off container of claim 1, wherein the roll-off container is constructed of plastic fiber mixture.

4. The roll-off container of claim 1, wherein the bottom of the container is integrally molded to a sidewall.

5. The roll-off container of claim 4, wherein the bottom is concave.

6. The roll-off container of claim 1, wherein an interior of the roll-off container is beveled.

7. The roll-off container of claim 1, further comprising a lip.

8. The roll-off container of claim 7, wherein the lip forms a top edge of the roll-off container.

9. A roll-off container, comprising:
a roll-off container comprising a front side and a rear side, the roll-off container configured, via a first rail and a second rai positioned on a bottom side of the roll-off container, to be onloaded, offloaded, and transported by a truck; and
an integrally molded sidewall integrally molded with a bottom.

10. The roll-off container of claim 9, wherein the roll-off container is constructed of plastic.

11. The roll-off container of claim 9, wherein the roll-off container is constructed of plastic fiber mixture.

12. The roll-off container of claim 9, wherein the bottom of the container is integrally molded to a sidewall.

13. The roll-off container of claim 12, wherein the bottom is concave.

14. The roll-off container of claim 9, wherein an interior of the roll-off container is beveled.

15. The roll-off container of claim 9, further comprising a lip.

16. The roll-off container of claim 15, wherein the lip forms a top edge of the roll-off container.

17. A roll-off container, comprising:
a roll-off container comprising a front side and a rear side, the roll-off container configured, via a first rail and a second rai positioned on a bottom side of the roll-off container, to be onloaded, offloaded, and transported by a roll-off truck or a hook lift roll-off truck; and
an integrally molded sidewall is connected to a bottom having a concave shape to facilitate the removal of a material from an interior of the roll-off container.

18. The roll-off container of claim 17, wherein an interior of the roll-off container is beveled.

19. The roll-off container of claim 18, further comprising a lip.

20. The roll-off container of claim 19, wherein the lip forms a top edge of the roll-off container.
